(19) United States
(12) Patent Application Publication
(10) Pub. No.: US 2026/0160917 A1
(43) Pub. Date: Jun. 11, 2026

(54) NON-INVASIVE CHARACTERIZATION OF WELLS

(71) Applicant: Halliburton Energy Services, Inc., Houston, TX (US)

(72) Inventors: Ahmed Elsayed FOUDA, Pearland, TX (US); Glenn WILSON, Houston, TX (US); Christopher Michael JONES, Houston, TX (US); Sriram SRINIVASAN, Houston, TX (US)

(73) Assignee: Halliburton Energy Services, Inc., Houston, TX (US)

(21) Appl. No.: 19/180,032

(22) Filed: Apr. 15, 2025

Related U.S. Application Data
(60) Provisional application No. 63/708,178, filed on Oct. 16, 2024.

(51) Int. Cl. G01V 3/08

(52) U.S. Cl. CPC G01V 3/083; G01V 3/081; G01V 3/088

(57) ABSTRACT

Aspects of the subject technology relate to characterizing well casings non-invasively. An electrical current can be established in at least a portion of a casing in a target well through indirect electrification. An electric field component, a magnetic field component, or a combination thereof that is generated by the electrical current in the casing can be measured by one or more sensors. The measurements of the electric field component, the magnetic field component, or the combination thereof can be processed to estimate one or more properties of either or both the casing of the target well and a formation surrounding the target well.

### CROSS-REFERENCE TO RELATED APPLICATIONS

This application claims the benefit of, and priority to, U.S. Provisional Application No. 63/708,178, filed on Oct. 16, 2024, the contents of which are hereby incorporated by reference in their entirety and for all purposes.

### TECHNICAL FIELD

The present technology pertains to characterizing wells in a non-invasive manner, and more particularly, to using indirect electrification of casing of a target well to non-invasively characterize the target well.

### BACKGROUND

Orphaned wells are legacy, e.g. non-producing, oil and gas wells with no solvent owner of record. Orphaned wells are environmental hazards and may jeopardize public health and safety by contaminating groundwater, emitting noxious gases like methane, littering the landscape with rusted and dangerous equipment, creating flooding and sinkhole risks, and harming wildlife. Undocumented orphaned wells (“UOWs”) are orphaned wells that are difficult to locate and assess due to insufficient or lack of records and limited imaging technology for their evaluation. Certain diagnostic tools and characterization techniques, such as downhole logging via wireline or coiled tubing conveyance, can be difficult to implement for characterizing UOWs because they require wellbore intervention. Specifically, such tools and techniques can be cost-prohibitive in characterizing UOWs. Further, many UOWs lack wellheads and casing running all the way to the surface, making such wellbore intervention tools and techniques unfeasible in characterizing UOWs.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

FIG. 1 illustrates a schematic diagram of an example wellbore operating environment, in accordance with various aspects of the subject technology.

FIG. 2 illustrates a flowchart for an example method of characterizing a well in a non-invasive manner using an electric current that is established through indirect electrification, in accordance with various aspects of the subject technology.

FIG. 3A illustrates a schematic diagram of an environment where casing electrification is achieved in a target well through an offset well, in accordance with various aspects of the subject technology.

FIG. 3B illustrates a top surface view of sensor placement in the environment shown in FIG. 3A, in accordance with various aspects of the subject technology.

FIG. 4A illustrates a schematic diagram of an environment where casing electrification is achieved from the surface through a loop or toroid, in accordance with various aspects of the subject technology.

FIG. 4B illustrates a top surface view of sensor placement in the environment shown in FIG. 4A, in accordance with various aspects of the subject technology.

FIG. 5A illustrates a schematic diagram of an environment where casing electrification is achieved through an offset wells and sensors on UAVs are used to capture measurements, in accordance with various aspects of the subject technology.

FIG. 5B illustrates a top surface view of sensor placement on UAVs in the environment shown in FIG. 5A, in accordance with various aspects of the subject technology.

FIG. 6A illustrates a schematic diagram of an environment where casing electrification is achieved from the surface through a loop or toroid sensors on UAVs are used to capture measurements, in accordance with various aspects of the subject technology.

FIG. 6B illustrates a top surface view of sensor placement on UAVs in the environment shown in FIG. 6A, in accordance with various aspects of the subject technology.

FIG. 7 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As discussed previously, UOWs are difficult to locate and assess due to a lack of records and limited imaging technology for their evaluation. Certain diagnostic tools and characterization techniques used in oil and gas operations, such as downhole logging via wireline or coiled tubing conveyance, can be difficult to implement for characterizing UOWs. Specifically, such tools and techniques can be cost-prohibitive in characterizing UOWs. Further, many UOWs lack wellheads and casing running all the way to the surface, making such wellbore intervention tools and techniques unfeasible. Estimates by the United States Environmental Protection Agency (EPA) for annual emissions from a study of two million nonproducing oil and gas wells were between 7 and 20 million metric tons per year of carbon dioxide equivalent emissions. To reduce these emissions and related environmental risks, there is a need for rapid and affordable well characterization of UOWs to ensure appropriate plugging operations can be completed in a timely and cost-effective manner. In this context, characterization means a method of quantifying the depth to top of casing, depth to the bottom of casing, and whether the casing string is continuous or has one or more discontinuities. Characterization can also include determining whether the well has leaked fluids (e.g., methane) into the surrounding geological formations.

Non-invasive characterization techniques for UOWs have been developed. However, such techniques are disadvantageous for many reasons. Specifically, such techniques can either require physical access to the well casing or are limited in depth of investigation. For example, electromagnetic time-domain reflectometry (TDR) has been used where an electrical pulse is propagated along the well casing. Various reflections associated with damage or discontinuities in the casing string are recorded as a function of time, and depth to damage or discontinuities are estimated from subsequent analyses. This technology can operate in the frequency range of 1.2 to 1.5 GHz and requires physical access to the well casing. Specifically, well casing at the well head is needed to implement this technology, which is often absent for UOWs. In yet another example, acoustic characterization can be performed where acoustic waves from ambient noise in and about the well casing is recorded. The travel time of the acoustic waves can be used to determine the depth of the casing or distance to any discontinuity in the casing. Similar to TDR, acoustic characterization techniques are dependent on physical access to the well casing, e.g. from the well head which may be absent for UOWs.

In another example, ground penetrating radar (GPR) can be used to characterize UOWs, regardless of whether the casing extends to the top of the well. However, ground penetrating radar has a limited depth of investigation of several meters. In another example, direct current electrification can be used to characterize the well. Specifically, a current can be applied at the well casing. As follows, the electric and/or magnetic field surrounding the well can be measured to characterize the well. Direct current electrification can only be implemented if the casing reaches the well head, so that direct current can be applied to the casing. It needs to be appreciated that direct current electrification is enabled with a very low frequency alternating current source, e.g., a square or rectangular waveform repeated with a duty cycle. At low frequencies, the electromagnetic fields can be approximated with a DC limit.

The disclosed technology addresses the foregoing by establishing a current through a target well through indirect electrification. This is advantageous as a current can be generated regardless of whether the casing fails to extend to the well head or there are gaps, or otherwise damage, in the casing in the well. As follows, an array of sensors can be used to measure the electric and/or magnetic fields generated by the induced current. A processing workflow can then be applied to invert the electric and/or magnetic field measurements and create models or maps of well casing properties, such as electrical conductivity, chargeability, and magnetic permeability. Such maps can then be used to inform plugging and abandonment processes.

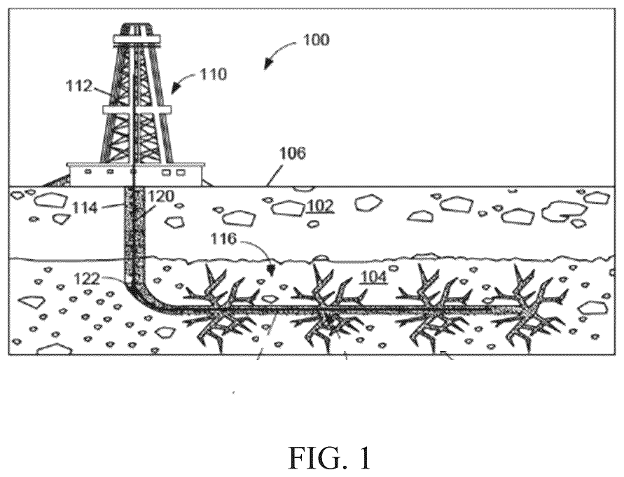

FIG. 1 illustrates a schematic diagram of an example wellbore operating environment. As depicted in FIG. 1, the operating environment 100 includes a wellbore 114 that penetrates a formation 102 for the purpose of recovering hydrocarbons, storing hydrocarbons, injecting of water or carbon dioxide, or the like in formation 104. In certain embodiments, the purpose of the operating environment 100 is carbon capture & storage (CCS) and includes equipment associated with that purpose (not shown in FIG. 1). In certain embodiments, the purpose of the operating environment 100 is geothermal energy capture and includes equipment associated with that purpose (not shown in FIG. 1).

As depicted in FIG. 1, formation 102,104 are subterranean formations, although it is noted that formations 102,104 may be a subsea formation. In certain locations, there are a plurality of underground formations 102, 104. The wellbore 114 may extend substantially vertically away from the Earth's surface 106 over a vertical wellbore portion, or may deviate at any angle from the Earth's surface 106 over a deviated or horizontal wellbore portion 116. In alternative operating environments, portions or substantially all of the wellbore 114 may be vertical, deviated, horizontal, and/or curved. The wellbore 114 may be drilled into the formations 102, 104 using any suitable drilling technique. As shown, a drilling or servicing rig 110 disposed at the surface 106 (which may be the surface of the Earth, a seafloor surface, or a sea surface) comprises a derrick 112 from which a tubular string 120 (e.g., a drill string, a tool string, a segmented tubing string, a jointed tubing string, or any other suitable conveyance, or combinations thereof) is positioned within or partially within the wellbore 114. The tubular string 120 may include two or more concentrically positioned strings of pipe or tubing (e.g., a first work string may be positioned within a second work string). The drilling or servicing rig 110 may include a motor driven winch and other associated equipment for lowering the tubular string into the wellbore 114. Alternatively, a mobile workover rig, a wellbore servicing unit (e.g., coiled tubing units), or the like may be used to lower the work string into the wellbore 114. In such an environment, the tubular string 120 may be utilized in drilling, stimulating, completing, or otherwise servicing the wellbore, or combinations thereof. A drilling or servicing rig 110 may also comprise other equipment. In certain types of operations, a fluid 122 is forced down the tubular string 120 and out through perforations 124 to fracture the formations 104 that surround the perforations 124.

While FIG. 1 depicts a stationary drilling rig 110, one of ordinary skill in the art will readily appreciate that mobile workover rigs, wellbore servicing units (such as coiled tubing units), and the like may be employed. It is noted that while the figures or portions thereof may exemplify horizontal or vertical wellbores, the principles of the presently disclosed apparatuses, methods, and systems, may be similarly applicable to horizontal wellbore configurations, conventional vertical wellbore configurations, deviated wellbore configurations, and any combinations thereof. The horizontal, deviated, or vertical nature of any figure is not to be construed as limiting the wellbore to any particular configuration or formation.

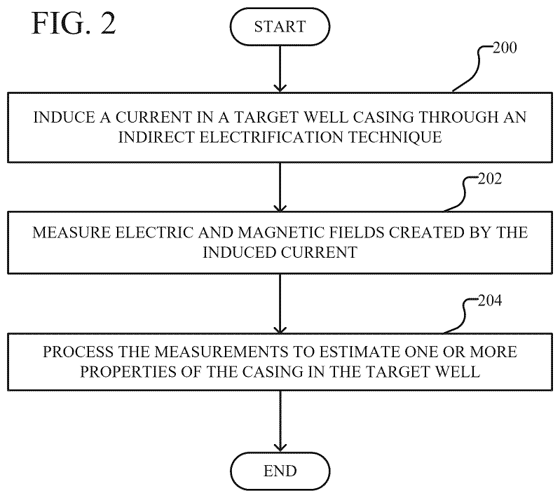

The operating environment 100 shown in FIG. 1 can be abandoned and ultimately become a UOW. In turn, an indirect electrification technique can be used to characterize the well in a non-invasive manner. FIG. 2 illustrates a flowchart for an example method of characterizing a well in a non-invasive manner using an electric current that is established through indirect electrification, in accordance with various aspects of the subject technology. The method shown in FIG. 2 is provided by way of example, as there are a variety of ways to carry out the method. Additionally, while the example method is illustrated with a particular order of steps, those of ordinary skill in the art will appreciate that FIG. 2 and the modules shown therein can be executed in any order and can include fewer or more modules than illustrated. Each module shown in FIG. 2 represents one or more steps, processes, methods or routines in the method.

At module 200, a current is induced in a target well through an indirect electrification technique. An indirect electrification technique can include an applicable technique where a casing is electrified via electromagnetic coupling without the electromagnetic sources (e.g., electrodes) directly contacting the casing. For example, an indirect electrification technique can include a technique in which the casing is electrified without directly applying electricity through the casing at the well head, such placing an electrode at the surface in the proximity of the wellhead and the counter electrode at the surface a distance from the well. In another example, an indirect electrification technique can include a technique in which the casing is electrified without disposing a tool in the well to contact the casing, such placing an electrode at the surface in the proximity of the well and the counter electrode at the surface a distance from the well. In using an indirect electrification technique, the deficiencies presented by missing sections of casings in UOWs can be overcome.

An indirect electrification technique can be implemented through one or more indirect electrification systems. Indirect electrification systems, as will be discussed in greater detail later, can include systems and components that can establish a current in a casing of a target well through an indirect electrification technique based on either galvanic or inductive excitation. For example, indirect electrification systems can include current generators and bipole electrode configurations that are capable of generating a current in a casing of a target well in an indirect electrification manner. Bipole electrode configurations can include large spans between the electrodes such that each electrode locally manifests as an electrical monopole. An applicable current can be established through an indirect electrification technique in the casing of the target well. For example, a current with a frequency between 0.001 Hz to 1000 kHz can be established in the casing of the target well.

One example of an indirect electrification technique can comprise injecting current through a second well in a vicinity of the target well to establish the electric current in the casing of the target. Specifically, a magnetic field generated by the injected current can induce the electric current in the casing of the target well. Another example of an indirect electrification technique can comprise injecting current through a second well or an underground monopole in a vicinity of the target well. The underground monopole can be an electrode that is dug into the formation adjacent to the target well. As follows, the injected current can be conducted through a formation to the casing of the target well to establish the electrical current in the casing of the target well. Additionally, existing conductive structures such as well casings can themselves be employed as sensing or detection points. Specifically, voltages or currents induced in these existing casings or similar conductive infrastructure, when measured, provide valuable electromagnetic response data. Utilizing such existing structures as detection points enhances characterization accuracy by capturing subsurface signals directly and complementing measurements obtained from surface-based or aerial sensors.

In yet another example of an indirect electrification technique, an inductive source such as a loop or toroid can be positioned in proximity to a well head of the target well. As follows, a current can be run through the loop or toroid to generate electromagnetic fields that induce the electrical current in the casing of the target well. The loop or toroid can be positioned on a ground surface in proximity to the well head of the target well. Alternatively, the loop of toroid can be airborne in proximity to the well head of the target well, e.g. through an unmanned aerial vehicle (“UAV”). Table 1 shows examples of different excitation sources and sensor configurations.

TABLE 1

| | | Wells with accessible well heads on site | |
|---|---|---|---|
| | | Yes | No |
| Site | Yes | Source: Indirect Casing | Source: Indirect Casing |
| accessible | | Electrification through | Electrification from |
| for sensor | | offset well(s) | surface |
| deployment | | Sensors: E/H-field on | Sensors: E/H-field |
| | | surface sensors | sensors on surface |
| | No | Source: Indirect Casing | Source: Indirect Casing |
| | | Electrification through | Electrification from |
| | | offset well(s) | UAVs? |
| | | Sensors: H-field sensors | Sensors: E/H-field |
| | | on UAVs | sensors on UAVs |

At module 202, electric and/or magnetic field components that are created by the induced current are measured. The electric and/or magnetic field components can be measured by applicable sensors. Such sensors can be placed at applicable positions for measuring the electric and/or magnetic fields created by the induced current. For example, the sensors can be deployed on a ground surface about the well head of the target well. In another example, the sensors can be deployed on UAVs in proximity to the well head of the target well.

Applicable sensors for measuring electric and/or magnetic field components can include induction coil magnetometers, fluxgate magnetometers, Hall-effect sensors, and capacitive electric-field sensors. Sensors may be physical or virtual, as in the case of distributed fiber sensing with magnetic or electric field interactions. Further, quantum enhanced sensors may be used such as but not limited to Rydberg atom detectors, nitrogen vacancy detectors, and squeezed light detectors coupled to an electromagnetic interaction material, such as but not limited to, lithium niobate, silicon nitride, and electro-mechanical oscillators. For example, induction coil magnetometers can detect variations in the magnetic field generated by induced currents, making them suitable for detecting casing discontinuities and corrosion at significant depths. Capacitive electric-field sensors, on the other hand, can precisely measure electric fields at or near the surface, facilitating detailed mapping of leakage plumes. These sensors may be arranged on stationary surface arrays for targeted, high-resolution surveys, or mounted on UAV platforms for rapid assessment of larger or inaccessible areas.

At module 204, the measurements are processed to estimate properties of the casing in the target well. Specifically, a model-based inversion, a pre-trained machine learning model, a regression model, or a combination thereof as part of processing the measurements of an electric field component and/or a magnetic field component, or the combination thereof to estimate one or more properties of the casing of the target well. Specifically, a workflow can be applied where the measurements are inverted to create the maps of the casing properties. Casing properties can include applicable properties of the casings such as electrical conductivity and magnetic permeability. Estimating the one or more properties of the casing of the target well can further comprise generating maps of either or both electrical conductivity distribution and magnetic permeability distribution of the casing versus depth as part of the one or more properties.

In processing the measurements to estimate properties of the casing in the target well, a model-based inversion, a pre-trained machine learning model, a regression model, or a combination thereof can be employed. The model-based inversion method may utilize forward modeling of Maxwell's equations or simplified assumptions thereof, applying numerical techniques such as finite element methods (FEM), finite difference methods (FDM), and finite volume methods (FVM). These inversion approaches may be conducted in one-dimensional (1D), two-dimensional (2D), or three-dimensional (3D) geometric settings, depending on the complexity and spatial extent of the target environment. The inversion process can explicitly incorporate geological structures, including strata and formations whose electrical, magnetic, and electromagnetic properties may be independently constrained by auxiliary measurements, such as resistivity logs, seismic surveys, or well-log data. Additionally, the inversion workflow may account for the presence of other artifact-producing conductive materials or infrastructure within the surveyed region, including but not limited to adjacent well casings, pipelines, power lines, drainage systems, or other metallic objects. By accurately modeling these influencing factors, the inversion can robustly estimate casing continuity, conductivity, magnetic permeability, and possible corrosion or discontinuities.

Similarly, machine learning approaches can be applied to process the measurements and predict casing properties. Such methods may include simple supervised regression mappings, which directly correlate electromagnetic measurements to casing attributes. More advanced factor-based machine learning techniques, such as Variational Autoencoders (VAEs), can be employed for dimensionality reduction and feature extraction, improving the interpretability and robustness of the casing property predictions. Additionally, physics-informed machine learning methods may be utilized, wherein neural operators such as Fourier Neural Operators (FNOs) are trained using observed measurement data alongside governing physical laws, for instance, Maxwell's equations embedded within the neural network's training cost function. This physics-constrained training approach ensures that learned relationships honor the underlying electromagnetic principles, providing physically consistent predictions even in data-sparse environments. The integration of these various methodologies offers flexibility, enhanced predictive accuracy, and reliability for characterizing subterranean casing conditions in complex operational scenarios.

Machine learning operators, such as Fourier Neural Operator (FNO) or Physics Informed Neural Operator (PINO), may be trained to approximate the broadband wave equation relating surface electric and magnetic fields to casing currents. Trained machine learning operators may be used in an inversion workflow to process sensor data, e.g. in real-time. In another embodiment, machine learning models may be trained to directly predict casing parameters from electric and magnetic field measurements. Real-time can be defined as near instantaneous (e.g., consider sampling rates, etc.) and can include latency in communication (e.g., telemetry, etc.). For example, real-time can be instantaneous if communication between a controller and models are of zero latency. However, if the communication between a controller and models has as latency of 1 minute then real-time can be instantaneous plus 1 minute. In general, real-time means instantaneous plus latency or other system delay time. Other system delay time can include transmission time delay, acquisition time delay, processing time delay, or other system delays.

Hydrocarbon fluids that leak and migrate into the formation around or above the casing may geochemically alter the surrounding formation, and create alteration zones, e.g., the formation of pyrite minerals. The minerals formed these alteration zones may exhibit frequency-dependent resistivity, implying they accumulate and discharge electrical charge during and after excitation. This induced polarization response is typically parameterized as a DC resistivity and a chargeability via a relaxation model, e.g., the Cole-Cole relaxation model. Specifically, a workflow can be applied where the electric and/or magnetic field measurements are inverted to create the maps of the casing properties from the DC resistivity, and maps implying a plume due to leakage from the chargeability. Casing properties can include applicable properties of the casings such as electrical conductivity and magnetic permeability. Plume properties can include applicable properties such as electrical conductivity and chargeability, and may be used to infer the state of any legacy plugging operations.

The gathering and processing of measurements can be performed in an automated fashion, e.g. without human intervention. Specifically, the measurements can be automatically gathered and sent for processing. In turn the measurements can be received and processed to automatically identify one or more properties of the casing of the target well. The measurements can be sent to a remote location, e.g. the cloud or an edge computing device for processing. In turn, the measurements can be processed at the remote location to identify the properties. The identified properties, e.g. casing maps, can then be sent on-site.

The identified properties of the casing can be sent to a user, e.g. a user on site. The user can then interpret the properties and make plugging and abandonment decisions for the target well. As discussed previously, this can reduce safety and environmental risks presented by the target well.

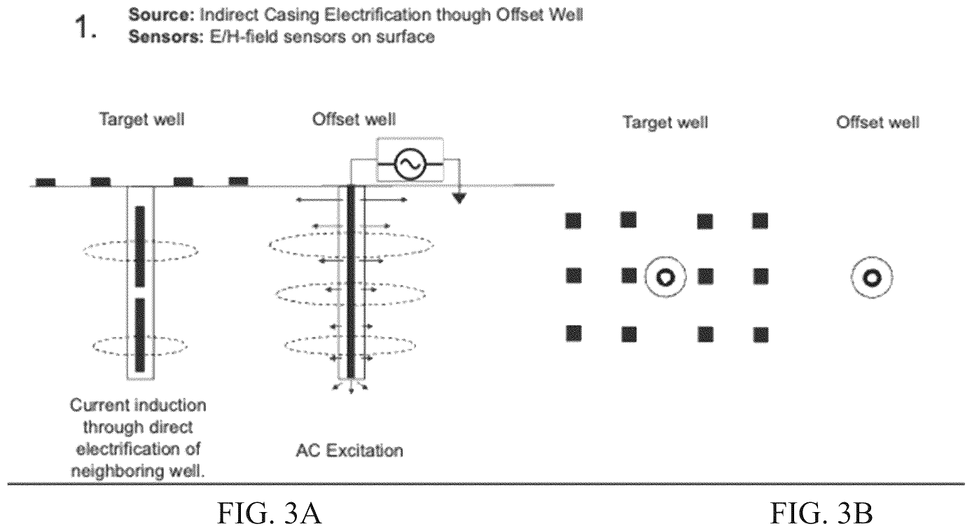

FIG. 3A illustrates a schematic diagram of an environment where casing electrification is achieved in a target well through an offset well, in accordance with various aspects of the subject technology. As shown in FIG. 3A, the casing in the target well is indirectly electrified by AC excitation in an offset well. Specifically, current can be induced in the target well through direct electrification of the neighboring/offset well.

FIG. 3B illustrates a top surface view of sensor placement in the environment shown in FIG. 3A, in accordance with various aspects of the subject technology. The sensors can comprise an applicable type of sensor. Specifically, the sensors can be E/H-field sensors. The sensors, as shown in FIG. 3B, are placed on the surface or in proximity to the surface in a grid pattern about the target well.

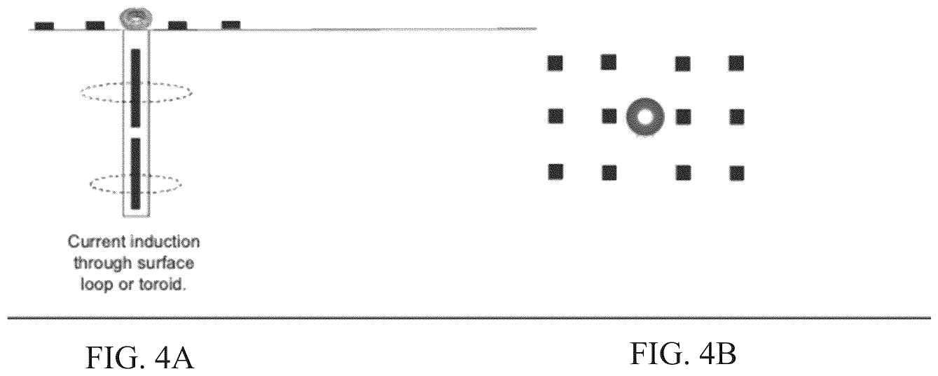

FIG. 4A illustrates a schematic diagram of an environment where casing electrification is achieved from the surface, in accordance with various aspects of the subject technology. As shown in FIG. 4A, the casing in the target well is indirectly electrified through a surface source. Specifically, the target well can be indirectly electrified through a surface loop or toroid.

FIG. 4B illustrates a top surface view of sensor placement in the environment shown in FIG. 4A, in accordance with various aspects of the subject technology. The sensors can comprise an applicable type of sensor. Specifically, the sensors can be E/H-field sensors. The sensors, as shown in FIG. 4B, are placed on the surface or in proximity to the surface in a grid pattern about the target well.

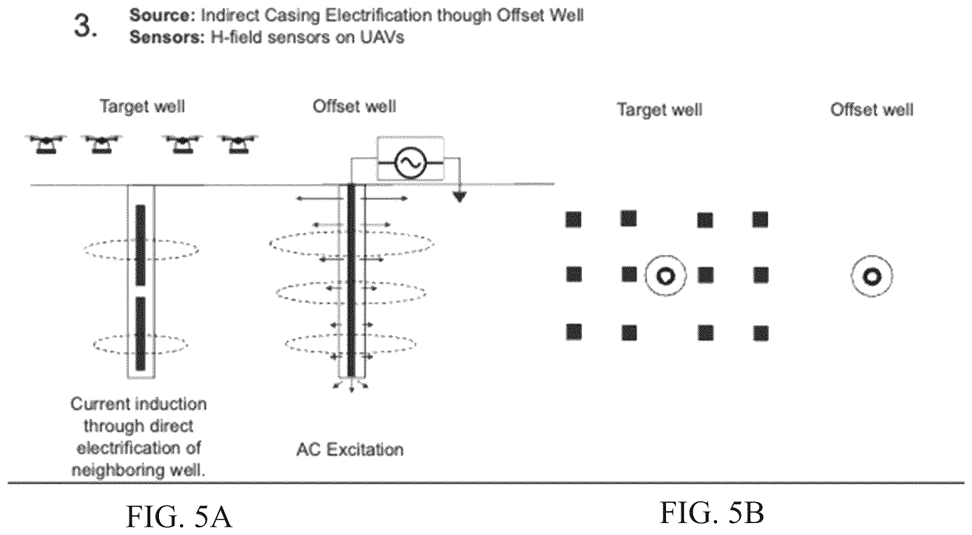

FIG. 5A illustrates a schematic diagram of an environment where casing electrification is achieved through an offset wells and sensors on UAVs are used to capture measurements, in accordance with various aspects of the subject technology. As shown in FIG. 5A, the casing in the target well is indirectly electrified by AC excitation in an offset well. Specifically, current can be induced in the target well through direct electrification of the neighboring/offset well.

FIG. 5B illustrates a top surface view of sensor placement on UAVs in the environment shown in FIG. 5A, in accordance with various aspects of the subject technology. The sensors can comprise an applicable type of sensor. Specifically, the sensors can be H-field sensors. The sensors, as shown in FIG. 5B, are positioned above the surface through an applicable mechanism or system. Specifically, the sensors are integrated with UAVs that operate to position the sensors above the surface. The sensors can form an applicable pattern, such as a grid pattern about the target well.

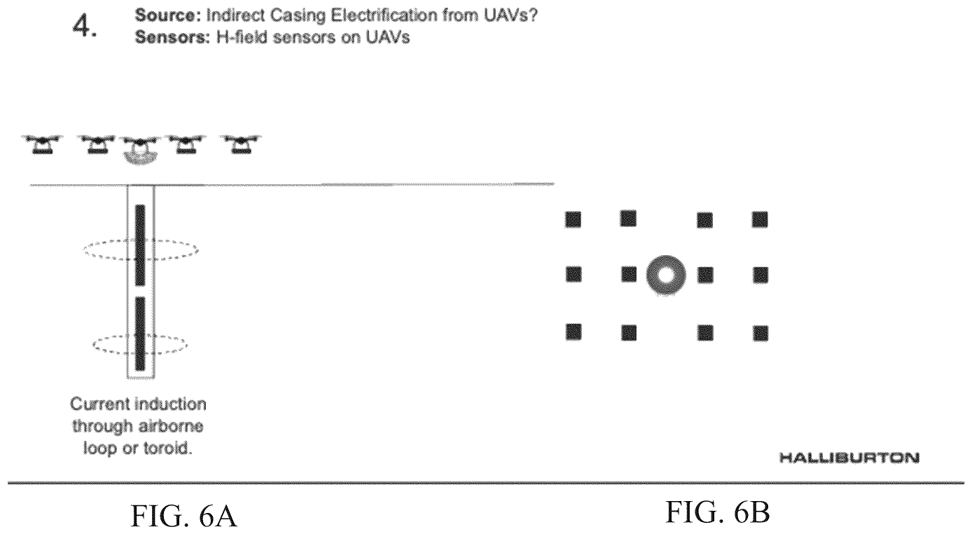

FIG. 6A illustrates a schematic diagram of an environment where casing electrification is achieved from the surface through a loop or toroid sensors on UAVs are used to capture measurements, in accordance with various aspects of the subject technology. As shown in FIG. 6A, the casing in the target well is indirectly electrified through a surface source. Specifically, the target well can be indirectly electrified through a surface loop or toroid.

FIG. 6B illustrates a top surface view of sensor placement on UAVs in the environment shown in FIG. 6A, in accordance with various aspects of the subject technology. The sensors can comprise an applicable type of sensor. Specifically, the sensors can be H-field sensors. The sensors, as shown in FIG. 5B, are positioned above the surface through an applicable mechanism or system. Specifically, the sensors are integrated with UAVs that operate to position the sensors above the surface. The sensors can form an applicable pattern, such as a grid pattern about the target well.

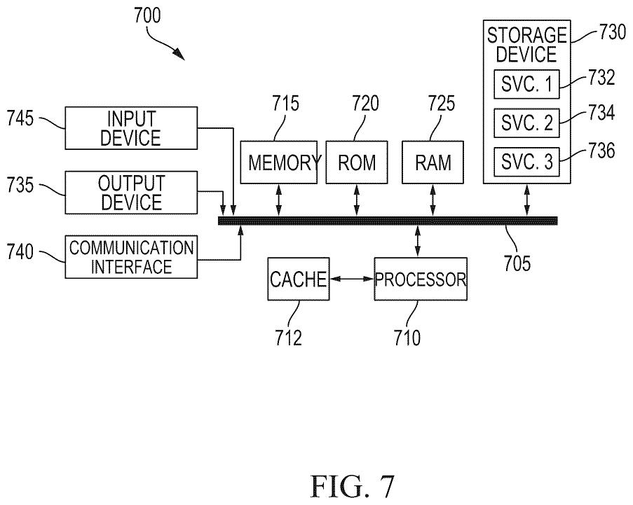

FIG. 7 illustrates an example computing device architecture 700 which can be employed to perform various steps, methods, and techniques disclosed herein. Specifically, the computing device architecture can be integrated with the electromagnetic imager tools described herein. Further, the computing device can be configured to implement the techniques of controlling borehole image blending through machine learning described herein.

As noted above, FIG. 7 illustrates an example computing device architecture 700 of a computing device which can implement the various technologies and techniques described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Illustrative examples of the disclosure include:

Embodiment 1. A method comprising: establishing, through indirect electrification, an electrical current in at least a portion of a casing in a target well; measuring, by one or more sensors, at least one electric and/or magnetic field component, or a combination thereof that is generated by the electrical current in the casing; and processing the measurements of the electric field component, the magnetic field component, or the combination thereof to estimate one or more properties of either or both the casing of the target well and a formation surrounding the target well.

Embodiment 2. The method of Embodiment 1, wherein the target well is an undocumented orphaned well.

Embodiment 3. The method of either Embodiment 1 or 2, further comprising injecting current through a second well in a vicinity of the target well to establish the electric current in the casing of the target well through indirect electrification, wherein a magnetic field generated by the injected current induces the electric current in the casing of the target well.

Embodiment 4. The method of any of Embodiments 1 through 3, further comprising injecting current through a second well in a vicinity of the target well, wherein the injected current is conducted through a formation to the casing of the target well to establish the electrical current in the casing of the target well.

Embodiment 5. The method of any of Embodiments 1 through 4, further comprising: positioning a loop or toroid in proximity to a well head of the target well; and running a current through the loop or toroid to generate electromagnetic fields that induce the electrical current in the casing of the target well.

Embodiment 6. The method of Embodiment 5, wherein the loop or toroid are positioned on a ground surface in proximity to the well head of the target well or airborne on an unmanned aerial vehicle in proximity to the well head of the target well.

Embodiment 7. The method of any of Embodiments 1 though 6, wherein a frequency of the electrical current established in the casing in the target well is within a range of 0.001 Hz to 1000 kHz.

Embodiment 8. The method of any of Embodiments 1 through 7, wherein the one or more sensors are deployed on a ground surface or airborne on an unmanned aerial vehicles.

Embodiment 9. The method of any of Embodiments 1 through 8, wherein the casing of the target well is not accessible from a surface at a well head, the casing of the target well has discontinuities, or a combination thereof.

Embodiment 10. The method of any of Embodiments 1 through 9, further comprising applying a model-based inversion, a pre-trained machine learning model, a regression model, or a combination thereof as part of processing the measurements of at least one electric and/or magnetic field component, or the combination thereof to estimate one or more properties of the casing of the target well.

Embodiment 11. The method of any of Embodiments 1 through 10, wherein estimating the one or more properties of the casing of the target well further comprises generating maps of either or both electrical conductivity distribution and magnetic permeability distribution of the casing versus depth as part of the one or more properties.

Embodiment 12. The method of any of Embodiments 1 through 11, further comprising informing plugging and abandonment operation decisions in the target well with the one or more properties of the casing of the target well.

Embodiment 13. The method of any of Embodiments 1 through 12, further comprising: transmitting the measurements of the electric field component, the magnetic field component, or the combination thereof as information to a remote location; processing the information at the remote location to identify the one or more properties of the casing of the target well at the remote location; and sending the one or more properties from the remote location to a user on site at the target well.

Embodiment 14. The method of any of Embodiments 1 through 13, further comprising: transmitting the measurements of the electric field component, the magnetic field component, or the combination thereof as information to one or more edge devices; processing the information at the one or more edge devices to identify the one or more properties of the casing of the target well at the one or more edge devices; and sending the one or more properties from the one or more edge devices to a user on site at the target well.

Embodiment 15. A system comprising: one or more processors; and at least one computer-readable storage medium having stored therein instructions which, when executed by the one or more processors, cause the one or more processors to: establish, through indirect electrification, an electrical current in at least a portion of a casing in a target well; measure, by one or more sensors, an electric field component, a magnetic field component, or a combination thereof that is generated by the electrical current in the casing; and process the measurements of the electric field component, the magnetic field component, or the combination thereof to estimate one or more properties of either or both the casing of the target well and a formation surrounding the target well.

Embodiment 16. A non-transitory computer-readable storage medium storing instructions for causing one or more processors to: establish, through indirect electrification, an electrical current in at least a portion of a casing in a target well; measure, by one or more sensors, an electric field component, a magnetic field component, or a combination thereof that is generated by the electrical current in the casing; and process the measurements of the electric field component, the magnetic field component, or the combination thereof to estimate one or more properties of either or both the casing of the target well and a formation surrounding the target well.

Embodiment 17. A system comprising: an indirect electrification system configured to establish, through indirect electrification, an electrical current in at least a portion of a casing in a target well; one or more sensors configured to measure an electric field component, a magnetic field component, or a combination thereof that is generated by the electrical current in the casing; one or more processors that execute instructions stored on at least one computer-readable storage medium to process the measurements of the electric field component, the magnetic field component, or the combination thereof to estimate one or more properties of either or both the casing of the target well and a formation surrounding the target well.

Embodiment 18. The system of Embodiment 17, wherein the indirect electrification system is implemented in a second well in a vicinity of the target well and the indirect electrification system is configured to inject current through the second well to establish the electric current in the casing of the target well through a magnetic field that is generated by the injected current in the second well and induces the electric current in the casing of the target well.

Embodiment 19. The system of either Embodiment 17 or 18, wherein the indirect electrification system is implemented in a second well in a vicinity of the target well or an underground monopole in the vicinity of the target well and the indirect electrification system is configured to inject current that is conducted through a formation to the casing of the target well to establish the electrical current in the casing of the target well.

Embodiment 20. The system of any of Embodiments 17 through 19, wherein the indirect electrification system is implemented through a loop or toroid with a current through the loop or toroid in proximity to a well head of the target well and the current through the loop or toroid generates electromagnetic fields that induce the electrical current in the casing of the target well.

Embodiment 21. A system comprising means for performing a method according to any of Embodiments 1 through 14.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
establishing, through indirect electrification, an electrical current in at least a portion of a casing in a target well;
measuring, by one or more sensors, at least one electric and/or magnetic field component, or a combination thereof that is generated by the electrical current in the casing; and
processing the measurements of the electric field component, the magnetic field component, or the combination thereof to estimate one or more properties of either or both the casing of the target well and a formation surrounding the target well.

2. The method of claim 1, wherein the target well is an undocumented orphaned well.

3. The method of claim 1, further comprising injecting current through a second well in a vicinity of the target well to establish the electric current in the casing of the target well through indirect electrification, wherein a magnetic field generated by the injected current induces the electric current in the casing of the target well.

4. The method of claim 1, further comprising injecting current through a second well in a vicinity of the target well, wherein the injected current is conducted through the formation to the casing of the target well to establish the electrical current in the casing of the target well.

5. The method of claim 1, further comprising:
positioning a loop or toroid in proximity to a well head of the target well; and
running a current through the loop or toroid to generate electromagnetic fields that induce the electrical current in the casing of the target well.

6. The method of claim 5, wherein the loop or toroid are positioned on a ground surface in proximity to the well head of the target well or airborne on an unmanned aerial vehicle in proximity to the well head of the target well.

7. The method of claim 1, wherein a frequency of the electrical current established in the casing in the target well is within a range of 0.001 Hz to 1000 kHz.

8. The method of claim 1, wherein the one or more sensors are deployed on a ground surface or airborne on an unmanned aerial vehicles.

9. The method of claim 1, wherein the casing of the target well is not accessible from a surface at a well head, the casing of the target well has discontinuities, or a combination thereof.

10. The method of claim 1, further comprising applying a model-based inversion, a pre-trained machine learning model, a regression model, or a combination thereof as part of processing the measurements of at least one electric and/or magnetic field component, or the combination thereof to estimate one or more properties of the casing of the target well.

11. The method of claim 1, wherein estimating the one or more properties of the casing of the target well further comprises generating maps of either or both electrical conductivity distribution and magnetic permeability distribution of the casing versus depth as part of the one or more properties.

12. The method of claim 1, further comprising informing plugging and abandonment operation decisions in the target well with the one or more properties of the casing of the target well.

13. The method of claim 1, further comprising:
transmitting the measurements of the electric field component, the magnetic field component, or the combination thereof as information to a remote location;
processing the information at the remote location to identify the one or more properties of the casing of the target well at the remote location; and
sending the one or more properties from the remote location to a user on site at the target well.

14. The method of claim 1, further comprising:
transmitting the measurements of the electric field component, the magnetic field component, or the combination thereof as information to one or more edge devices;
processing the information at the one or more edge devices to identify the one or more properties of the casing of the target well at the one or more edge devices; and
sending the one or more properties from the one or more edge devices to a user on site at the target well.

15. A system comprising:
one or more processors; and
at least one computer-readable storage medium having stored therein instructions which, when executed by the one or more processors, cause the one or more processors to:
establish, through indirect electrification, an electrical current in at least a portion of a casing in a target well;
measure, by one or more sensors, an electric field component, a magnetic field component, or a combination thereof that is generated by the electrical current in the casing; and
process the measurements of the electric field component, the magnetic field component, or the combination thereof to estimate one or more properties of either or both the casing of the target well and a formation surrounding the target well.

16. A non-transitory computer-readable storage medium storing instructions for causing one or more processors to:
establish, through indirect electrification, an electrical current in at least a portion of a casing in a target well;
measure, by one or more sensors, an electric field component, a magnetic field component, or a combination thereof that is generated by the electrical current in the casing; and
process the measurements of the electric field component, the magnetic field component, or the combination thereof to estimate one or more properties of either or both the casing of the target well and a formation surrounding the target well.

17. A system comprising:
an indirect electrification system configured to establish, through indirect electrification, an electrical current in at least a portion of a casing in a target well;
one or more sensors configured to measure an electric field component, a magnetic field component, or a combination thereof that is generated by the electrical current in the casing; and
one or more processors that execute instructions stored on at least one computer-readable storage medium to process the measurements of the electric field component, the magnetic field component, or the combination thereof to estimate one or more properties of either or both the casing of the target well and a formation surrounding the target well.

18. The system of claim 17, wherein the indirect electrification system is implemented in a second well in a vicinity of the target well and the indirect electrification system is configured to inject current through the second well to establish the electric current in the casing of the target well through a magnetic field that is generated by the injected current in the second well and induces the electric current in the casing of the target well.

19. The system of claim 17, wherein the indirect electrification system is implemented in a second well in a vicinity of the target well or an underground monopole in the vicinity of the target well and the indirect electrification system is configured to inject current that is conducted through the formation to the casing of the target well to establish the electrical current in the casing of the target well.

20. The system of claim 17, wherein the indirect electrification system is implemented through a loop or toroid with a current through the loop or toroid in proximity to a well head of the target well and the current through the loop or toroid generates electromagnetic fields that induce the electrical current in the casing of the target well.
